(19) United States
(12) Patent Application Publication
(10) Pub. No.: US 2010/0023798 A1
(43) Pub. Date: Jan. 28, 2010

(54) ERROR RECOVERY AND DIAGNOSIS FOR PUSHDOWN AUTOMATA

(75) Inventors: Henricus Johannes Maria Meijer, Mercer Island, WA (US); John Wesley Dyer, Monroe, WA (US); Thomas Meschter, Renton, WA (US); Cyrus Najmabadi, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/179,684

(22) Filed: Jul. 25, 2008

(51) Int. Cl. G06F 11/07

(52) U.S. Cl. 714/2; 714/E11.023

(57) ABSTRACT

Error recovery and diagnosis is afforded for pushdown automata. Upon detection of an error, a recovery strategy is selected and dispatched to recover from the error to place an automaton in an error free state to enable continued processing. In one instance, recovery strategies can be specified and matched with respect to automaton configuration. Errors can be diagnosed as a function of the difference between a first error configuration and a second recovered configuration.

### BACKGROUND

An automaton is an abstract model for a finite state machine (FSM) or simply a state machine. A state machine consists of a finite number of states, transitions between those states, as well as actions. States define a unique condition, status, configuration, mode, or the like at a given time. A transition function identifies a subsequent state and any corresponding action given current state and some input. In other words, upon receipt of input, a state machine can transition from a first state to a second state, and an action or output event can be performed as a function of the new state. A state machine is typically represented as a graph of nodes corresponding to states and optional actions and arrows or edges identifying transitions between states.

A pushdown automaton is an extension of a regular automaton that includes the ability to utilize memory in the form of a stack. While a normal automaton can transition as a function of input and current state, pushdowns can transition based on the input, current state, and stack value. Furthermore, a pushdown automaton can manipulate the stack. For example, as part of a transition a value can be pushed to or popped off a stack. Further yet, the stack can simply be ignored or left unaltered.

In one instance, automata can provide bases for various compiler components such as parsers. Parsers include scanners or lexers that first perform lexical analysis on a program to identify language tokens. Subsequently or concurrently, parsers can perform syntactic analysis of the tokens. Parsers can be implemented utilizing an automaton that only accepts strings in accordance with a language grammar. Input and tokens can either be accepted or rejected based on a resultant state upon stopping of the automaton. In other words, the input can be either recognized or unrecognized. In many cases, the parser employs recognized input to generate a parse tree of tokens to enable subsequent processing (e.g., code generation, programmatic assistance, versioning . . . ).

Errors can occur with respect to execution of a pushdown automaton. Typically, error recovery is handled by inserting error productions that essentially work as exceptions, where an error is the exception and the exception is handled by the presence of an error-non-terminal production or an ancestor production in a grammar, for example.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to error recovery and diagnosis for pushdown automata, among other things. Upon detection of an error associated with execution of an automaton, a recovery strategy can be selected and executed to recover from the error. In accordance with one aspect of the disclosure, recovery strategies can include a configuration defining applicability and an action. Where a configuration associated with an error matches a strategy configuration, the strategy can be employed to recover from the error by modifying or replacing an error configuration with a recovery configuration. According to another aspect, error diagnosis can be computed as a function of the difference between error and recovery configurations.

A number of recovery strategies are available to recover from errors. In fact, recovery strategies are pluggable enabling users to easily fine tune error recovery by way of a self-defined or third party strategy in accordance with yet another aspect of the disclosure. Various mechanisms are also provided to facilitate selection of an appropriate recovery strategy. According to one aspect, strategy selection can be learned.

Further yet, recovery is not limited to pushdown automaton errors. According to an aspect, similar functionality can also be applied with respect to runtime exception handling and ambiguity resolution.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an error recovery system in accordance with an aspect of the disclosed subject matter.

FIG. 2 is a block diagram of a representative recovery component in accordance with an aspect of the disclosure.

FIG. 3 is a block diagram of a representative dispatch component according to a disclosed aspect.

FIG. 4 is a block diagram of an error recovery and diagnosis system according to a disclosed aspect.

FIG. 5 is a block diagram of a representative diagnosis component in accordance with an aspect of the disclosed subject matter.

FIG. 6a illustrates an exemplary state stack and input buffer associated with a parsing error.

FIG. 6b depicts an exemplary state stack and input buffer associated with an error recovery strategy.

FIG. 6c illustrates an exemplary state stack and input buffer associated with a recovery.

FIG. 7 is a flow chart diagram of an error recovery method in accordance with an aspect of the disclosure.

FIG. 8 is a flow chart diagram of a recovery strategy method according to an aspect of the disclosed subject matter.

FIG. 9 is a flow chart diagram of a method of error recovery in accordance with an aspect of the disclosed subject matter.

FIG. 10 is a flow chart diagram of method of error diagnosis in accordance with a disclosed aspect.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods pertaining to error recovery and diagnosis, among other things, are described in detail hereinafter. Upon detection of an error in pushdown automaton execution, a recovery strategy can be selected from amongst a plurality of strategies and dispatched to recover from an error by modifying or replacing an error configuration with a recovered configuration. In fact, in one embodiment, strategies can be specified with applicable configurations, matched to a current configuration, and executed to produce a new configuration. Error diagnosis or identification can be accomplished by computing the difference between the error configuration and the recovered configuration. Error messages can be presented based on an identified error to provide meaningful feedback to enable the error to be fixed. In accordance with one aspect, the error recovery and diagnosis can be separate from or independent of an associated pushdown automaton to provide flexibility in applicability of recovery strategies and diagnosis functionality without altering the automaton.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

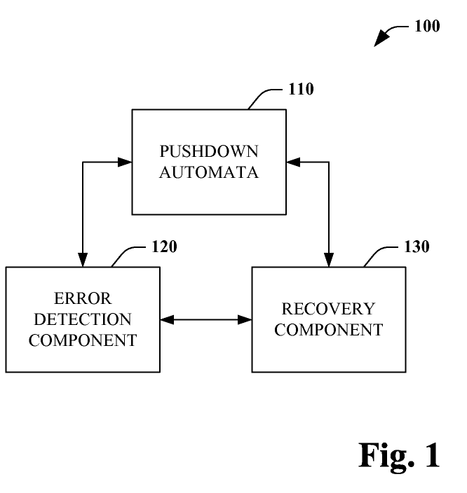

Referring initially to FIG. 1, an error recovery system 100 is illustrated in accordance with an aspect of the claimed subject matter. The system 100 includes a pushdown automaton component 110 that performs some action. The pushdown automaton component 110 corresponds to a finite state machine equipped with a memory mechanism, such as a stack, to influence state transitioning. Although not limited thereto, in one embodiment, the pushdown automaton component 110 corresponds to a parser, which performs syntactic analysis of program code. In particular, the parser can be a shift-reduce parser that employs a stack to store tokens that are not yet recognized with respect to a grammar. That is, tokens are shifted or placed onto a stack from an input/lookahead buffer until they can be reduced or recognized in terms of a grammar rule. The pushdown automaton component 110 is not limited to a parser, of course. It could also be embodied as other language processing mechanisms (e.g., lexing/scanning, serialization/deserializaiton . . . ), recursive program, or workflow application, among other things. For purposes of clarity and understanding with respect to various aspects of the claimed subject, however, the pushdown automaton component 110 will be discussed with respect to the parser embodiment.

The automaton component 110 is communicatively coupled to an error detection component 120 and an error recovery component 130. The detection component 120 is a mechanism that identifies errors or error states in automaton component processing. Upon error detection via one or more known or novel means, automaton configuration, such as a stack and input buffer, are made available for inspection and modification by the error recover component 130. The error recovery component 130 recovers from error by modifying or replacing a current configuration associated with an error with a new, error free configuration. As will be described further infra, the recovery component 130 can resolve errors by utilizing one or more standard and/or custom error recovery strategies

Pushdown automata such as parsers often deal with errors and recovery from error. When performing parsing for a compiler and/or integrated development environment (IDE), for instance, broken code is not only encountered often, it is the norm. When someone is typing along, code is almost always unable to be compiled and run. Bunches of error states are encountered while a user authors code. While a correct state might be reached, it is likely followed by more error states. Accordingly, error recovery is important in terms of being able to support/work in such an environment.

Conventionally, error recovery for auto-generated parsers, for instance, is handled by inserting error productions in a grammar that essentially function as exceptions handled by the presence of an error non-terminal production or ancestor production. This is very inflexible and has lead to a trend away from employment of automatic parser generators for this and other reasons. In particular, industrial compilers and/or IDEs generally require robust error recovery typically fined tuned for specific scenarios. By way of example, suppose a user types in the following erroneous code snippet in C#:

for (var x in foo)
{
}

The problem is not discovered until the “in” keyword is reached, but the problem actually occurs with the introduction of the “for” keyword, which should be a “foreach” keyword. This is incredibly difficult to handle with traditional error recovery strategies such as error productions. The system 100 can address this by way of the recovery component 130 functioning external to the automaton component 110, as previously described, so as not to require modification of the automaton component 110.

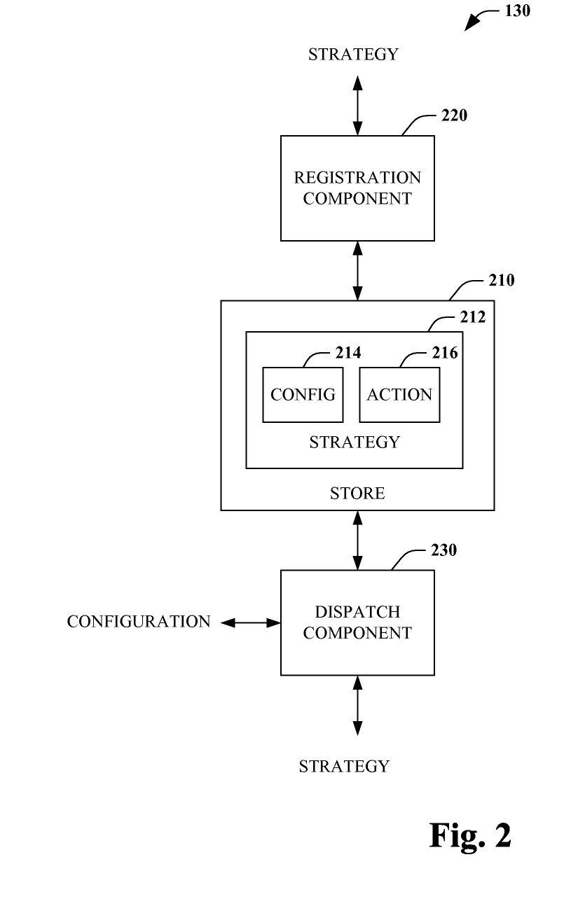

FIG. 2 depicts a representative recovery component 130 in further detail in accordance with an aspect of the claimed subject matter. As shown, the recovery component 130 includes, or is otherwise communicatively coupled to, a strategy store 210 that houses a plurality or recovery strategies 212. In accordance with one embodiment, a strategy can include a configuration component 214 and an action component 216. The configuration component 214 specifies an automaton and/or error configuration that identifies a context for which the strategy 212 is applicable. For example, a stack and input/lookahead buffer can be captured by the configuration. The action component 216 provides an action or function for resolving an applicable error. For instance, the action component 216 can modify or replace the error configuration with a new, error-free configuration.

The recovery component 130 can further comprise a registration component 220 coupled to the strategy store 210. The registration component 220 registers a strategy 212 with the recovery component 130 and saves the strategy or a reference thereto on the store 210. Consequently, users can plug in their own or third party strategies to fine tune recovery. In accordance with one aspect, an arbitrarily rich program language can be provided to facilitate strategy specification. For example, a pattern matching language can be developed to aid specification of strategies that specify applicability based on patterns and matching thereof. Of course, generalized recovery patterns not dependent upon pattern matching but search, for instance, can be developed and registered with the recovery component 130 as well.

Furthermore, the representative recovery component 130 includes a dispatch component 230 communicatively coupled to the strategy store 210. The dispatch component 230 is a mechanism that dispatches or invokes a particular recovery strategy to deal with an error. Accordingly, the dispatch component 230 can includes some mechanism to facilitate selection of the appropriate strategy amongst a plurality of strategies as a function of a configuration, for example.

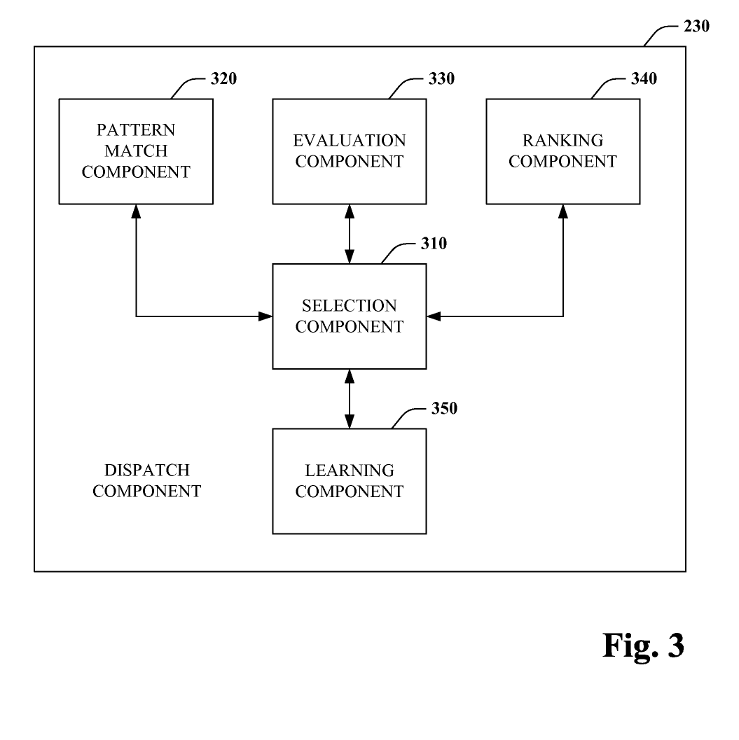

Turning attention to FIG. 3, a representative dispatch component 230 is illustrated in accordance with an aspect of the claimed subject matter. The dispatch component 230 includes a selection component 310 that selects a strategy for dispatch in response to an error, for instance. To aid identification of an appropriate strategy, the selection component 310 can interact with pattern match component 320, evaluation component 330, ranking component 340, and learning component 350.

The match component 320 performs pattern matching to identify applicable strategies. As previously mentioned, strategies can specify configurations to which they apply. Configuration can refer to state of a stack, input buffer, and/or variables, among other things. The match component 320 seeks to match a current or error configuration with a specified strategy configuration. The match need not be exact since strategy configurations may seek to match multiple scenarios. As such, the strategy configuration can include a limited amount of information and/or wildcards, among other things.

The evaluation component 330 evaluates execution of one or more strategies. Before committing to a strategy, a number of candidate strategies can be executed to determine their value compared to others. For example, new configurations can be produced by all candidate strategies and evaluated. Each configuration will likely remedy a particular error for which it was designed and allow processing to proceed, but some strategies may cause other errors. For example, where code is parsed and a “foreach” loop is incorrectly specified as a “for” loop there are at least two strategies for resolving the error. One way to recover is to remove or delete the entire loop structure. Another strategy is to replace the “for” keyword with a “foreach” keyword. The former recovery strategy is a quite naïve and unsophisticated approach. As such, it might result in further errors down the line. Accordingly, evaluation component 330 would score the former strategy below the latter.

The ranking component 340 can ascribe a ranking to a plurality of strategies as a function of a variety of factors. In particular, the ranking can pertain to relevance of a strategy to a particular error as well as the “goodness” of the resolution. Information utilized to produce a ranking can come from internal or external sources. For example, the ranking component can receive input from the evaluation component 330. Additionally or alternatively, the ranking component 340 can receive or retrieve information regarding ranking from external ranking services, social networks, or the like.

The dispatch component 230 can also include a learning component 350 that can influence strategy selection by learning which strategies are most applicable based on user programming habits, preference, and/or historical information, among other things. In accordance with one embodiment, applicability of an error recovery strategy can be learned by recording error configurations and matching recovery strategies. Over time, the component 350 can learn to choose recovery strategies automatically for future unseen error configurations.

Furthermore, it is to be noted that errors can be personal in nature. Accordingly, information can be utilized to infer appropriate strategies given a particular user or entity. By way of example, consider a user who cannot remember how to specify a “for” loop condition in a particular language. Once an error is observed and resolved for this user many times, the component 350 can learn the fact that the user has trouble with encoding this particular construct and recovery strategies previously employed. Subsequently, if the same or similar error appears a recovery strategy can be easily identified and/or preferred over others.

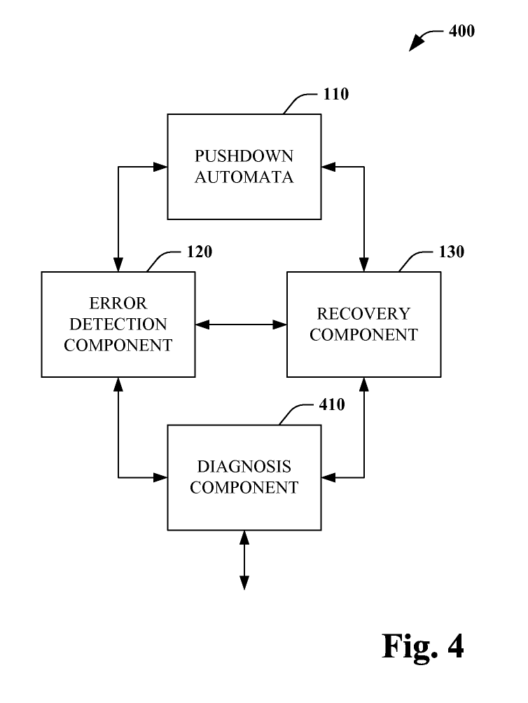

Referring to FIG. 4, an error recovery and diagnosis system 400 is illustrated in accordance with an aspect of the claimed subject matter. Similar to system 100 of FIG. 1, the system 400 includes pushdown automaton 110, error detection component 120, and recovery component 130, as previously described. In brief, errors in processing by the pushdown automaton 110 can be identified by the error detection component 120 and resolved by the recovery component 130. Further, the system 400 includes an error diagnosis component 410 communicatively coupled to the error detection component 120 and recovery component 130. The error diagnosis component 120 identifies errors to fix or eliminate. In accordance with one embodiment, errors can be identified by comparing a first error configuration from the error detection component 120 with a second recovery configuration from the recovery component 130.

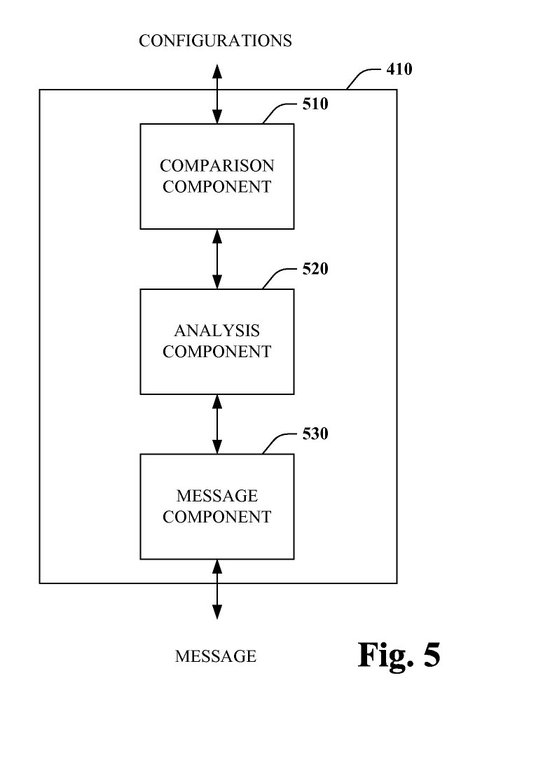

FIG. 5 depicts a representative diagnosis component 410 in accordance with an aspect of the claimed subject matter. In particular, the diagnosis component 410 includes a compare component 510, analysis component 520, and message component 530. The comparison component 510 receives or retrieves an error configuration and a recovery configuration and determines the difference between the two. This difference can be analyzed by analysis component 520 to identify one or more errors. Based on the error, message component 520 can generate a user message regarding the error including such things as identification of the error and suggestions for fixing the error.

It is to be appreciated that error messages and/or suggestions are easily modifiable by users. Accordingly, should a developer feel that an error message is not as helpful as first thought, it can be modified. Similar error recovery, error diagnosis component 530 can also be pluggable such that it can receive specification of errors and messages and employ them where appropriate.

It is to be noted that error diagnosis and error recovery are related yet distinct. Error diagnosis concerns provisioning good error messages to users about what they should probably do to fix their code so that it is in a working state. Error recovery, on the other hand, pertains to placing code in a condition in order to proceed with analysis, for example when parsing code as it is entered into an IDE. In particular, error recovery assumes some things. For example, code might not be structurally correct or might not have any structure. Accordingly, structure is forced on it to a point that allows further analysis so that a user can obtain meaningful information despite the broken state.

What follows is a brief example of how aspects of the claimed invention can be employed with respect to recovery and diagnosis. The sole purpose is to aid understanding of aspects of the claims. The example is not intended to limit the scope or spirit of the claims in any manner.

Consider an automatically generated left-to-right (LR) parser. When an error occurs, a call is made to a recovery mechanism and the current parsing configuration is passed. After recovery, diagnosis of the error is computed from the difference between the erroneous configuration and the recovered configuration. Below is an exemplary code snippet capturing the above:

```
var recoveredConfiguration
    = RecoverFromError(currentConfiguration);
var diagnosis
    = ComputeDiagnosis(currentConfiguration,
recoveredConfiguration);
```

Parsing configuration include a state stack and an input/lookahead buffer. The recovery method dispatches a particular recovery strategy based on the current parser configuration. Such dispatch can employ tree pattern matching to find the best applicable recovery strategy for a given error, among other things. For instance, reconsider the error previously given when a user types:

for (var x in foo)
{
}

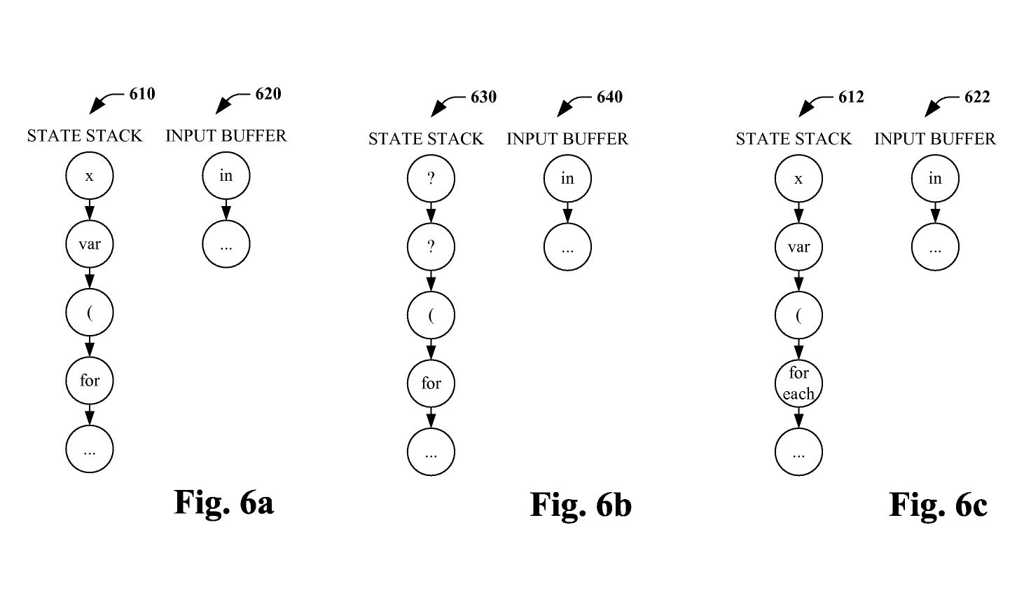

Turning attention to FIG. 6a, the state stack and input buffer are graphically depicted at a point when the error occurs. As shown, the state stack 610 includes “x” followed by “var” followed by “(” followed by “for” and previous tokens. The input buffer 620 includes the next token “in” and other tokens.

A recovery strategy configuration that matches the error is depicted in FIG. 6b. The configuration includes a state stack 630 including nodes “?”, “?”, “(”, “for” and other tokens as well as input buffer 640 that includes “in” among other tokens. In this case, the question marks act as wildcard characters such that the configuration matches any code that includes the prefix of a “for” construct, namely “(” and “for” with an input buffer including “in” as the next token.

Since the strategy configuration matches the current error configuration, the recovery strategy is dispatched, which will return a new or modified configuration as illustrated in FIG. 6c. As shown, state stack 612 includes “x” followed by “var” followed by “(” followed by “foreach” and previous tokens. The input buffer 620 includes the next token “in” and other tokens. This correctly replaces “for” with “foreach” in the state stack. Configuration or tree differencing, in this case, will detect that the only change was that “for” was replaced with “foreach” and a useful message can be constructed.

Users can easily specify tree patterns that correspond to errors and recover from those errors. This enables users to fine-tune their error recovery instead of only specifying broad patterns. Such a system can include a number of specific recovery cases as well as general recovery strategies, which are all based on prioritized tree matching.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, such mechanism can be employed to learn when a recovery strategy is applicable by saving a configuration when an error occurs and then detecting common parts of the configuration over several such errors.

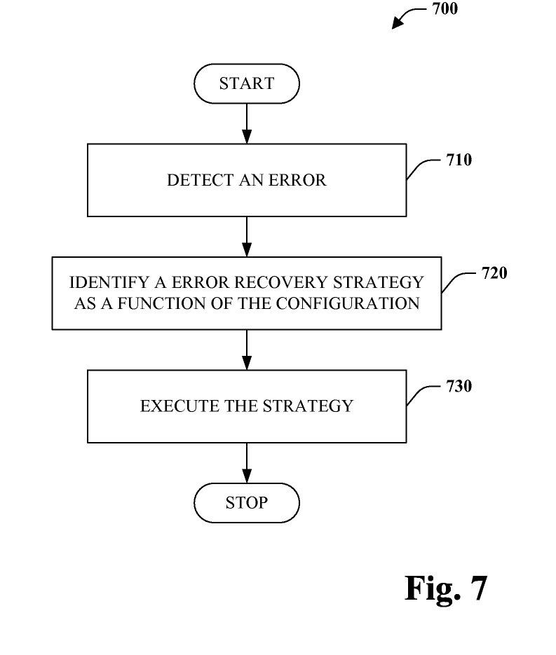

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of error recovery 700 is depicted in accordance with an aspect of the claimed subject matter. At reference numeral 710, an error is detected. An error can correspond to in instance in which there is no path for proceeding with processing, such as where a parser is unable to recognize a construct. At numeral 720, an error recovery strategy is identified as a function of configuration. In particular, there is a configuration (e.g., stack state, input/lookahead buffer . . . ) associated with the error and strategies can be specified with configurations that identify their applicability. Where a strategy configuration matches an error configuration, the strategy is applicable. At reference numeral 730, the strategy identified at 720 is executed or applied. The strategy can modify or generate a new configuration that is error free and processing can continue.

By way of example, consider a parser associated with an integrated development environment (IDE). Here, parsing is performed to generate parse trees that can be employed to provide assistance to programmers by way of automatic statement completion, intelligent suggestion, formatting, and/or colorization among other things. Parsing is employed as a user types. However, at any given moment, specified code is in a broken state as it is under development. Further yet, users often make mistakes authoring code. Accordingly, the parser needs to be able to operate in the presence of errors. To accomplish this error recovery can be employed. In this instance, a plurality of recovery strategies can be specified identifying applicability configurations. Upon identification of an error, a recovery strategy can be identified that matches a current erroneous configuration. The identified strategy can then be executed providing a new error free configuration that allows parsing to continue. In this manner, program assistance can be afforded for other code further down the line that the erroneous code.

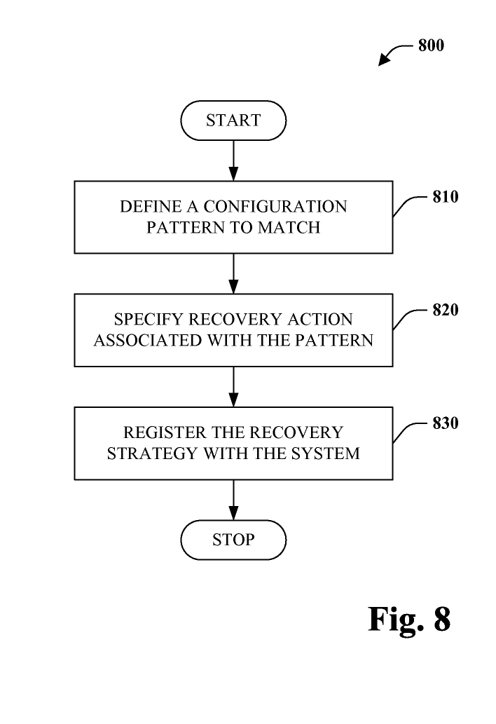

FIG. 8 is a flow chart diagram of a recovery strategy method 800 in accordance with an aspect of the claimed subject matter. At reference numeral 810, a configuration pattern is indentified to define strategy applicability. The configuration pattern can define a state associated with a system. For example, a state stack and an input/lookahead buffer can be specified. At numeral 820, a recovery action is defined with respect to the configuration pattern. The action can specify modification of an error configuration or replacement of the error configuration with a recovery configuration. Together, the configuration and action comprise an error recovery strategy. At reference numeral 830, the defined strategy is registered with a recovery system or component. In this manner, users can fine tune error recovery strategies rather than specifying broad patterns or rules. Moreover, this can be accomplished without altering an automaton such as a parser unlike conventional recovery solutions that rely on generating error production rules for a grammar.

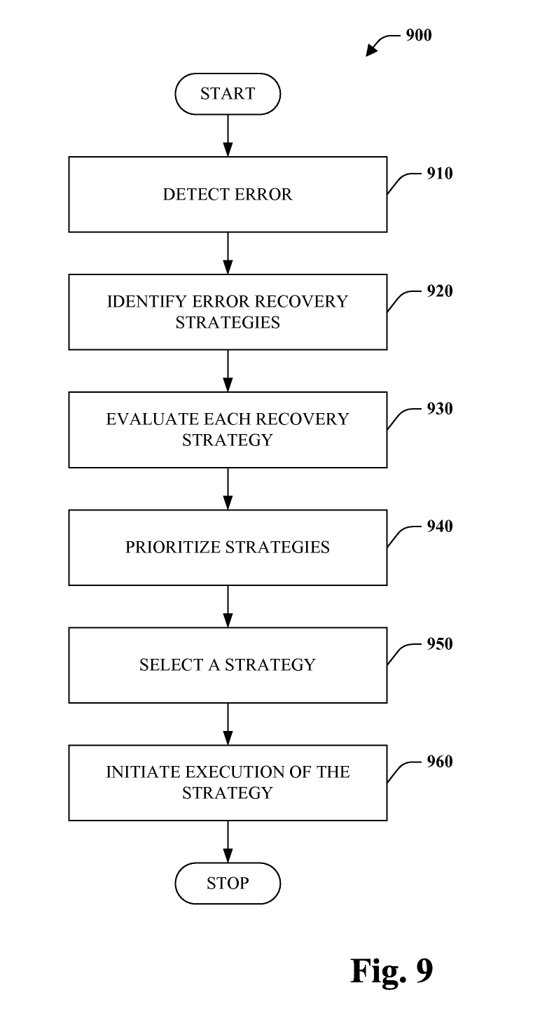

FIG. 9 depicts an error recovery method 900 in accordance with an aspect of the claimed subject matter. At reference numeral 910, an error is detected. At numeral 920, strategies are identified to effect recovery from the error. In one instance, such strategies may include a configuration that matches an error configuration. Alternatively, generalized recovery strategies can be identified. At reference 930, each applicable strategy is evaluated to facilitate identification of the best strategy to recover from the error. In accordance with one embodiment, each candidate strategy can be executed to determine and scrutinize any strategy side effects. For example, a strategy may cause additional unwanted errors. At numeral 940, the strategies are prioritized and/or ranked in accordance with the evaluation. For instance, a strategy with unwanted side effects can be ranked lower than one with no side effects. At reference 950, a strategy is selected as a function of the ranking. At numeral 950, execution of the selected strategy is initiated to effect error recovery.

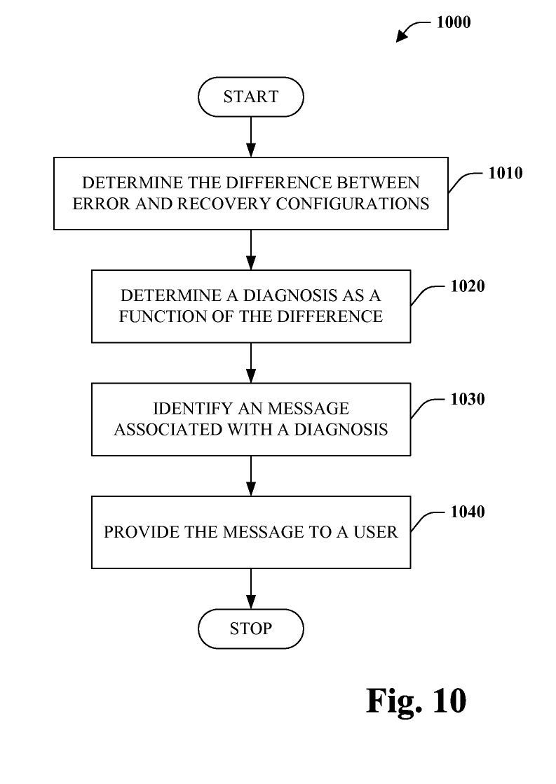

Referring to FIG. 10, a method of error diagnosis 1000 is depicted in accordance with an aspect of the claimed subject matter. At reference numeral 1010, the difference between an error configuration and a recovery configuration is determined. Where an error is detected, there is an associated configuration, which is modified or replaced by an error recovery strategy. At numeral 1020, error diagnosis is performed as a function of the difference. In other words, the error is identified. At reference 1030, a message associated with the identified error is located. At numeral 1040, the message is provided to a user to facilitate identification and correction of the error.

As previously mentioned, aspects of the claimed subject matter can be applied outside a parser setting. For example, such configurable error recovery can be applied to runtime exceptions. A call stack of instructions not yet executed corresponds to a stack of tokens not yet reduced. Further, a parser lookahead buffer can correspond to an instruction pointer of where execution is at with respect to instructions not yet executed. In these terms, if an exception occurs recovery from exceptions can be attempted based on pattern matching with respect to a call stack and instruction pointer.

Conventionally, exceptions are handled completely context independent. The same exception can be thrown in the context of very different call stacks and there is no way to make the handling dependent on context. The only thing provided is the exception and dispatch is provided on the exception type. Now, exception handling can be context dependent.

Further yet, it is to be appreciated error recovery can be implemented on a deployed program without altering the code. For example, error recovery strategies can be specified to address unhandled exceptions after the fact. When such an error is identified utilizing a specified configuration, then a corresponding recovery strategy can be dispatched. By way of example, consider an application programming interface (API) designed to perform file access that throws file open and file not exist exceptions, among others and over time there is a change to a network file system. Now suddenly, there can be a time out exception that was not present in the original API. Having exception handling outside a program can take care of new exceptions that where not there before or maybe there is a bug or certain exceptions handling was not implemented.

Still further yet, it is to be noted that the above described error recovery and diagnosis systems and methods need not be limited to errors or exceptions. The same or similar mechanism can be employed to deal with ambiguities. Where an error provides no option to proceed, ambiguities provide more than one option. Accordingly, an ambiguity strategy can be specified as a function of contextual configuration information that specifies a particular path. As per diagnosis, instead of an error message an explanation can be provided as to how an ambiguity was resolved.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

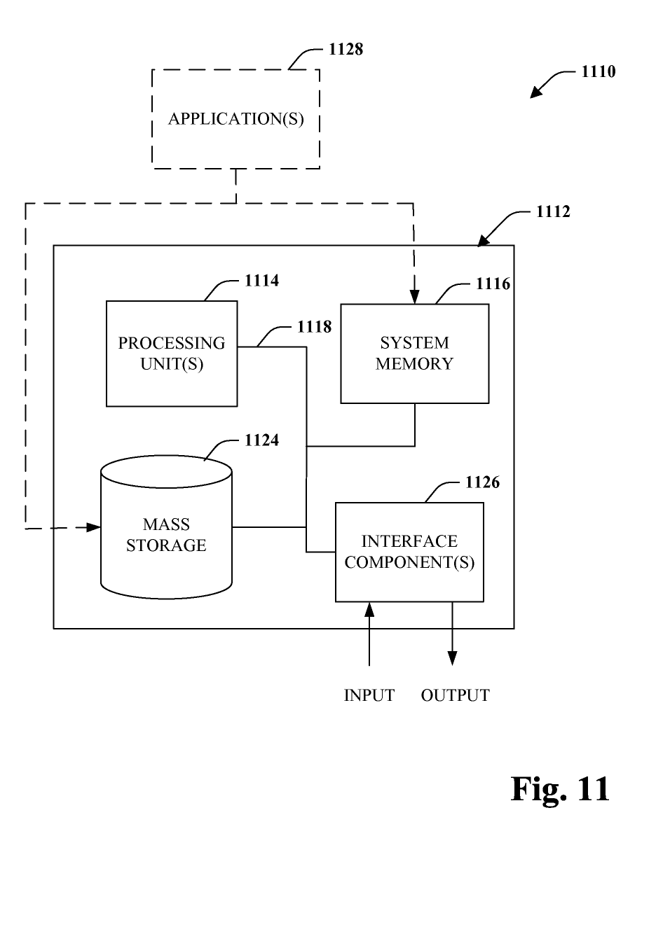

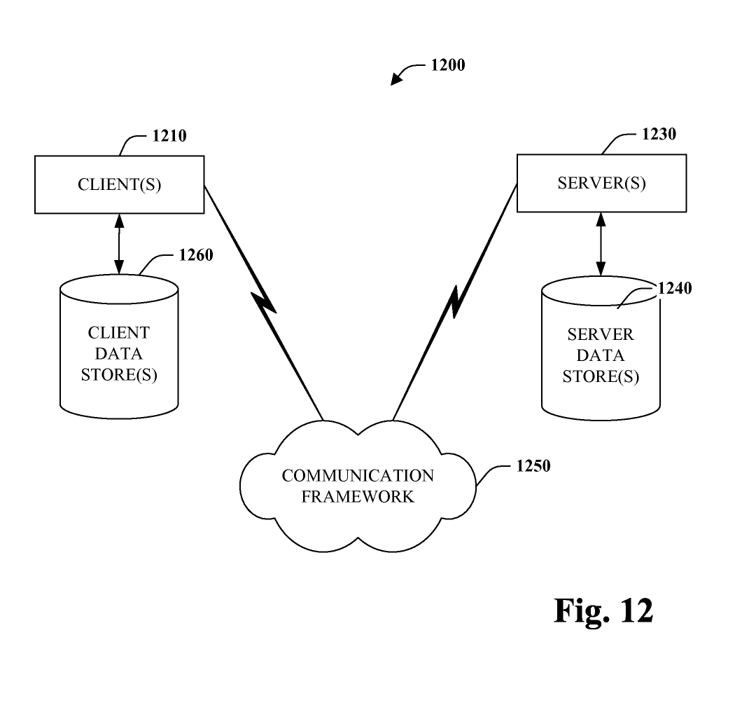

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. By way of example and not limitation, various components can be embodied as network services wherein one or more servers 1230 provide functionality to one or more clients 1210 across the communication framework. In one particular instance, one or more error recovery strategies can be provided by a server 1230 for download and employment with respect to a client 1210 based error recovery system or component. Further, yet information can be acquired from one or more clients 1210 and servers 1230 with respect to evaluating, prioritizing, and/or ranking strategies, among other things.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An error recovery system for pushdown automata, comprising:
a detection component that identifies an error during execution of a push down automaton; and
a recovery component external to the automaton that dispatches a strategy to recover from the error as a function of a current configuration.

2. The system of claim 1, the strategy includes a configuration that matches the current configuration and produces an error-free recovery configuration.

3. The system of claim 2, the strategy is specified in an arbitrarily rich pattern matching language.

4. The system of claim 2, further comprising a diagnosis component external to the automaton that generates an error message as a function of a difference between current and recovery configurations to aid error location and resolution.

5. The system of claim 2, further comprising a selection component that chooses a strategy for dispatch from amongst a plurality of matching strategies.

6. The system of claim 5, further comprising a component that executes one or more candidate strategies and evaluates their performance.

7. The system of claim 6, further comprising a component that ranks the candidate strategies as a function of performance and/or configuration, wherein rank information is derived from an internal or external source.

8. The system of claim 5, further comprising a component that infers the strategy as a function of historical data and/or user input.

9. The system of claim 1, further comprising a component that registers a plug-in strategy for dispatch by the recovery component.

10. The system of claim 1, the automaton is a computer program parser.

11. The system of claim 1, the error corresponds to a program exception and recovery refers to exception handling.

12. A method of error recovery and diagnosis, comprising:
dispatching a recovery strategy based on a first configuration associated with an error that produces a second configuration that recovers from the error; and
diagnosing the error as a function of a difference between the first and second configurations.

13. The method of claim 12, further comprising selecting the recovery strategy from a plurality of strategies.

14. The method of claim 13, further comprising executing one or more of the recovery strategies to facilitate selection of a most appropriate strategy.

15. The method of claim 13, further comprising learning programmer habits to aid selection of an applicable strategy.

16. The method of claim 12, further comprising registering provided recovery strategies, for use in error recovery, and/or error diagnosis functionality.

17. The method of claim 12, further comprising sending an error message on the diagnosed cause of the error to aid a user in fixing the error.

18. A parser error-recovery system, comprising:
means for recovering from a parsing error by dispatching a recovery strategy based on a parser configuration including stack state and input buffer; and
means for generating a diagnosis as a function of the difference between the parser configuration upon error detection and recovery.

19. The system of claim 18, further comprising a means for registering recovery strategies with the system for employment in recovering from errors.

20. The system of claim 18, further comprising a means for selecting the dispatched recovery strategy from a plurality of recovery strategies.
